(19) United States
(12) Patent Application Publication
(10) Pub. No.: US 2012/0278611 A1
(43) Pub. Date: Nov. 1, 2012

(54) VPN-BASED METHOD AND SYSTEM FOR MOBILE COMMUNICATION TERMINAL TO ACCESS DATA SECURELY

(75) Inventors: Bin HU, Shenzhen (CN); Yiyong WEN, Shenzhen (CN); Zhengwen JIANG, Shenzhen (CN)

(73) Assignee: SANGFOR NETWORKS COMPANY LIMITED

(21) Appl. No.: 13/347,705

(22) Filed: Jan. 11, 2012

(30) Foreign Application Priority Data
Apr. 26, 2011 (CN) 201110105772.8

(51) Int. Cl. H04L 9/00; G06F 17/00; H04L 29/06

(52) U.S. Cl. 713/153; 726/15; 726/1

(57) ABSTRACT

A VPN-based method for a mobile communication terminal to access data securely comprises: when a data security device is operating in the mobile communication terminal, the data security device allows the mobile communication terminal to access an intranet but inhibits the mobile communication terminal from accessing an external network; and when the data security device is not operating in the mobile communication terminal, a VPN server inhibits the mobile communication terminal from accessing the intranet. The data security device is disposed in the mobile communication terminal. The data security device cooperates with the VPN server to inhibit the user of the mobile communication terminal from sending protected files to the external network via a network when the data security device is deactivated and to inhibit applications running on the data security device from accessing networks outside the VPN resources to release the protected files to the external network.

### BACKGROUND

1. Technical Field

The present disclosure relates to the field of network security, and more particularly, to a VPN-based method and a VPN-based system for a mobile communication terminal to access data securely.

2. Description of Related Art

With rapid development of the mobile Internet and integrated circuit (IC) technologies, mobile communication terminals are now provided with powerful processing capabilities and are evolving from a kind of simple tool for making phone calls towards comprehensive information processing platforms. Users can download and browse various types of files easily from networks by means of their mobile communication terminals. Meanwhile, the mobile communication terminals have also become a kind of tool for mobile officing, and the users can use their mobile communication terminals to access intranet resources and data of respective intranets via Virtual Private Networks (VPNs) for purpose of telecommuting.

However, while the mobile communication terminals make officing convenient for the users, they also increase the risks that restricted data and confidential information of their respective companies are disclosed because of the following reason: mobile communication terminals that access the intranet resources via VPNs can also access other external networks, and some users may deliberately release important data from the intranet to the external networks at any time.

### BRIEF SUMMARY

The primary objective of the present disclosure is to provide a VPN-base method and a VPN-based system for a mobile communication terminal to access data securely, which can improve security of the intranet resources.

The present disclosure provides a VPN-base method for a mobile communication terminal to access data securely, comprising:

when a data security device is operating in the mobile communication terminal, the data security device allows the mobile communication terminal to access an intranet but inhibits the mobile communication terminal from accessing an external network; and

when the data security device is not operating in the mobile communication terminal, a VPN server inhibits the mobile communication terminal from accessing the intranet.

Preferably, operations of the data security device comprise:

generating an encryption key by the data security device; and

encrypting/decrypting data in the mobile communication terminal according to the encryption key.

Preferably, generating an encryption key by the data security device comprises:

downloading a key corresponding to the mobile communication terminal from the VPN server when the mobile communication terminal accesses VPN resources; and

calculating an encryption key according to the key and mobile communication terminal parameters, and the mobile communication terminal parameters comprise International Mobile Equipment Identity (IMEI) information and/or International Mobile Subscriber Identity (IMSI) information of the mobile communication terminal.

Preferably, the method further comprises the following step before encrypting/decrypting data in the mobile communication terminal according to the encryption key:

redirecting data written into the mobile communication terminal to a preset storage space, and the preset storage space is a storage space specified in the mobile communication terminal or a storage medium connected with the mobile communication terminal.

Preferably, operations of the data security device further comprise:

controlling the mobile communication terminal's access to the VPN resources according to a preset rights policy by the data security device.

The present disclosure further provides a VPN-based system for a mobile communication terminal to access data securely, which comprises a VPN server and a data security device operating in the mobile communication terminal. The VPN server is configured to inhibit the mobile communication terminal from accessing an intranet when the data security device is not operating in the mobile communication terminal. The data security device is configured to allow the mobile communication terminal to access the intranet but inhibit the mobile communication terminal from accessing an external network.

Preferably, the data security device comprises:

a key generating module, being configured to generate an encryption key; and

an encrypting/decrypting module, being configured to encrypt/decrypt data in the mobile communication terminal according to the encryption key.

Preferably, the key generating module comprises:

a downloading unit, being configured to download a key corresponding to the mobile communication terminal from the VPN server when the mobile communication terminal accesses VPN resources; and

a calculating unit, being configured to calculate an encryption key according to the key and mobile communication terminal parameters; and the mobile communication terminal parameters comprise IMEI information and/or IMSI information of the mobile communication terminal.

Preferably, the data security device further comprises:

a redirecting module, being configured to redirect data written into the mobile communication terminal to a preset storage space, and the preset storage space is a storage space specified in the mobile communication terminal or a storage medium connected with the mobile communication terminal.

Preferably, the data security device further comprises:

a rights controlling module, being configured to control the mobile communication terminal's access to the VPN resources according to a preset rights policy.

According to the VPN-base method and the VPN-based system for a mobile communication terminal to access data securely of the present disclosure, the data security device is disposed in the mobile communication terminal. The data security device cooperates with the VPN server to inhibit the user of the mobile communication terminal from sending protected files to an external network via a network when the data security device is deactivated and to inhibit applications running on the data security device from accessing networks outside the VPN resources to release the protected files to the external networks.

### BRIEF DESCRIPTION OF THE DRAWINGS

FIG. 1 is a schematic flowchart diagram of an embodiment of a VPN-based method for a mobile communication terminal to access data securely according to the present disclosure;

FIG. 2 is a schematic flowchart diagram of operations of a data security device in an embodiment of the VPN-based method for a mobile communication terminal to access data securely according to the present disclosure;

FIG. 3 is a schematic flowchart diagram of a process of generating an encryption key in an embodiment of the VPN-based method for a mobile communication terminal to access data securely according to the present disclosure;

FIG. 4 is another schematic flowchart diagram of operations of the data security device in an embodiment of the VPN-based method for a mobile communication terminal to access data securely according to the present disclosure;

FIG. 5 is a further schematic flowchart diagram of operations of the data security device in an embodiment of the VPN-based method for a mobile communication terminal to access data securely according to the present disclosure;

FIG. 6 is a schematic structural view of an embodiment of a VPN-based system for a mobile communication terminal to access data securely according to the present disclosure;

FIG. 7 is a schematic structural view of a data security device in an embodiment of the VPN-based system for a mobile communication terminal to access data securely according to the present disclosure;

FIG. 8 is a schematic structural view of a key generating module in an embodiment of the VPN-based system for a mobile communication terminal to access data securely according to the present disclosure;

FIG. 9 is another schematic structural view of the data security device in an embodiment of the VPN-based system for a mobile communication terminal to access data securely according to the present disclosure; and

FIG. 10 is a further schematic structural view of the data security device in an embodiment of the VPN-based system for a mobile communication terminal to access data securely according to the present disclosure.

Hereinafter, implementations, functional features and advantages of the present disclosure will be further described with reference to embodiments thereof and the attached drawings.

### DETAILED DESCRIPTION

It shall be understood that, the embodiments described herein are only intended to illustrate but not to limit the present disclosure.

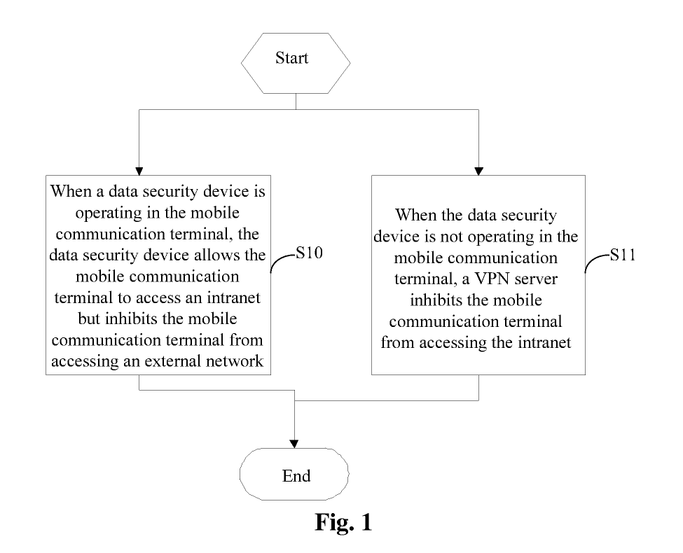

Referring to FIG. 1, an embodiment of a VPN-based method for a mobile communication terminal to access data securely is disclosed, which comprises:

step S10: when a data security device is operating in the mobile communication terminal, the data security device allows the mobile communication terminal to access an intranet but inhibits the mobile communication terminal from accessing an external network; and

step S11: when the data security device is not operating in the mobile communication terminal, a VPN server inhibits the mobile communication terminal from accessing the intranet.

In this embodiment, for convenience of description, a mobile communication terminal environment having no data security device operating therein is termed as a private environment, and a mobile communication terminal environment having a data security device operating therein is termed as an office environment. After a user connects to a VPN via the mobile communication terminal, the VPN-based data security device is downloaded and then installed in the mobile communication terminal automatically. The VPN-based data security device operates in the background to provide a file system access filtering layer for the mobile communication terminal, thus forming an office environment. When an application running in the office environment accesses a network through use of the network application program interface (API) function, the accessing behavior will firstly be intercepted by the data security device. The data security device determines whether the accessed destination address is a VPN intranet resource authorized to the user or not. If the destination address is an authorized intranet address, then data will be transmitted to the intranet through a VPN channel; and if the destination address is not the authorized intranet address, then the accessing behavior will be inhibited directly. Applications running in a private environment don't link up with the data security device, so even if the destination address to which network data is sent in the private environment is the intranet address, the network data still can not be transmitted to the intranet and the applications can not access the VPN intranet resources. In this way, the office environment can access the intranet but can not access the external network, while the private environment can access the external network but can not access the intranet. As a result, the office environment and the user's private environment are inhibited from communicating with each other, thus achieving the objective of separating the office environment from the user's private environment.

In this embodiment, the data security device is disposed in the mobile communication terminal. The data security device cooperates with the VPN server to inhibit the user of the mobile communication terminal from sending protected files to the external network via a network when the data security device is deactivated and to inhibit applications running on the data security device from accessing networks outside the VPN resources to release the protected files to the external network.

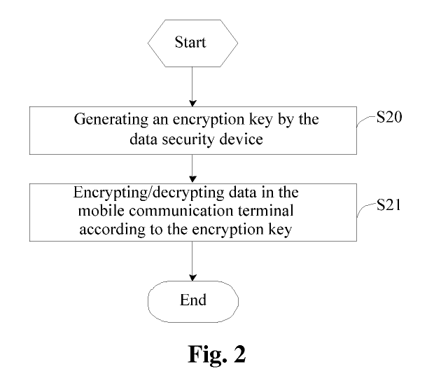

Referring to FIG. 2, in an embodiment, operations of the data security device comprise:

step S20: generating an encryption key by the data security device; and

step S21: encrypting/decrypting data in the mobile communication terminal according to the encryption key.

When the mobile communication terminal is connected to the VPN, all of the applications running in the mobile communication terminal must pass through the file system access filtering layer of the data security device to access the file system of the mobile communication terminal, and the file system access filtering layer controls the applications' access according to different rights. The data security device generates an encryption key for encrypting/decrypting data read from or written into the file system of the mobile communication terminal in the office environment. When the applications running in the office environment write data into the file system of the mobile communication terminal, the data security device utilizes the encryption key to encrypt the file content; and when the applications running in the office environment need to read downloaded files, the data security device obtains plaintext data by utilizing the encryption key to decrypt the file content and then outputs the plaintext data. The entire process of encrypting/decrypting the files is transparent to the user and is done automatically.

In this embodiment, as the data security device encrypts/decrypts the files transparently for the applications running in the office environment, the applications running in the private environment can not read data (which have already been encrypted in the office environment) through decrypting. Thus, the objective of separating data of the office environment from that of the user's private environment is achieved.

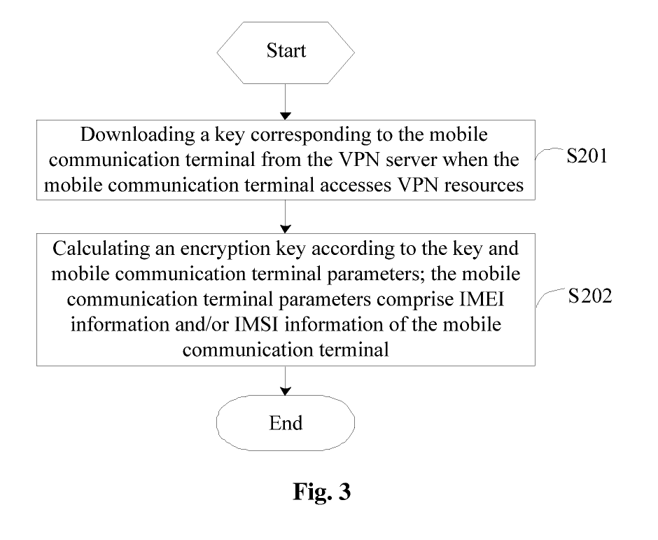

Referring to FIG. 3, in the aforesaid embodiment, the step S20 may comprise:

step S201: downloading a key corresponding to the mobile communication terminal from the VPN server when the mobile communication terminal accesses the VPN resources; and

every time the mobile communication terminal accesses the VPN resources, the data security device downloads from the VPN server a unique key associated with a VPN account of the mobile communication terminal.

step S202: calculating an encryption key according to the key and mobile communication terminal parameters. The mobile communication terminal parameters comprise IMEI information and/or IMSI information of the mobile communication terminal.

The data security device uses the downloaded key in combination with the mobile communication terminal parameters of the mobile communication terminal to generate the encryption key. The mobile communication terminal parameters may be IMEI information and/or IMSI information or other mobile communication terminal parameters that can be involved in the calculation of the encryption key.

In this embodiment, the data security device generates the encryption key according to the downloaded key every time the mobile communication terminal accesses the VPN resources, so even if the mobile communication terminal is lost, data in the mobile communication terminal will not be disclosed because the key keeps changing constantly.

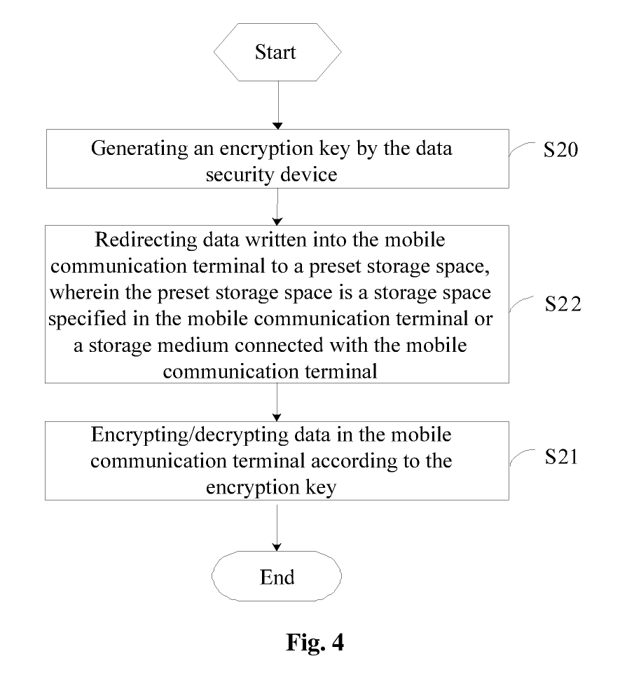

Referring to FIG. 4, in the aforesaid embodiment, the method may further comprise the following step before the step S21:

step S22: redirecting data written into the mobile communication terminal to a preset storage space. The preset storage space is a storage space specified in the mobile communication terminal or a storage medium connected with the mobile communication terminal.

When the applications running in the office environment writes a file (the file is termed as a virtual file in this embodiment) into the mobile communication terminal, the write operation is firstly intercepted by the data security device. The data security device will automatically redirect the write operation of the file to the preset storage space (termed as a real-world file), which may be a storage space specified in the mobile communication terminal or a storage medium connected with the mobile communication terminal such as a secure digital memory card (SD card). The data security device utilizes the encryption key to encrypt the file content. Meanwhile, the data security device stores data of correspondence relationships between the real-world file and the virtual file in the preset storage space. When the applications running in the office environment need to read a downloaded file, the data security device obtains the real-world file corresponding to the virtual file and redirects the read operation of the virtual file to the corresponding real-world file in the preset storage space. Moreover, the data security device obtains plaintext data by utilizing the encryption key to decrypt the content of the real-world file and then outputs the plaintext data to a top layer application. When the virtual file is deleted, the corresponding real-world file and the data of correspondence relationships will be deleted automatically. The entire process of redirecting and encrypting/decrypting the file is transparent to the user and is done automatically.

In this embodiment, as the data security device only redirects the applications running in the office environment transparently, the read or write operation will firstly be intercepted by the data security device when the applications running in the private environment read or write the virtual file. The data security device will not redirect the read or write operation of the file to the real-world file, so the applications only operate on the virtual file but not operate on the real-world file to modify or obtain the content of the real-world file, and this further improves the security of data in the mobile communication terminal.

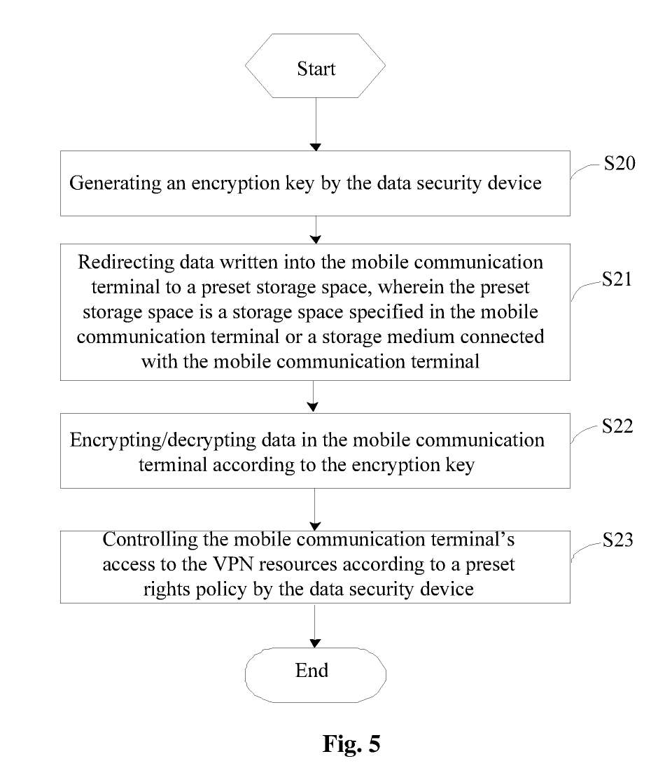

Referring to FIG. 5, in the aforesaid embodiment, operations of the data security device further comprise:

step S23: controlling the mobile communication terminal's access to the VPN resources according to a preset rights policy by the data security device.

The step S23 may be carried out before, after or at the same time as the step S20, step S21 and step S22.

The data security device provides an office environment interface for the user, and application icons currently installed on the mobile communication terminal are shown on the interface. Whether the application icons are displayed or not may be determined by the preset rights policy (which is generally a rights policy issued by the VPN). Only applications activated by clicking on the icons (termed as the applications running in the office environment) are allowed to access the VPN intranet resources, but are inhibited from accessing other network resources outside the VPN intranet resources allocated to the user. On the other hand, applications running in other ways (termed as the applications running in the private environment) are inhibited from accessing the intranet resources.

In this embodiment, the data security device determines which applications can or can not be used and what VPN resources can or can not be accessed in the office environment according to the preset rights policy, and this further improves the security of the mobile communication terminal's access to data.

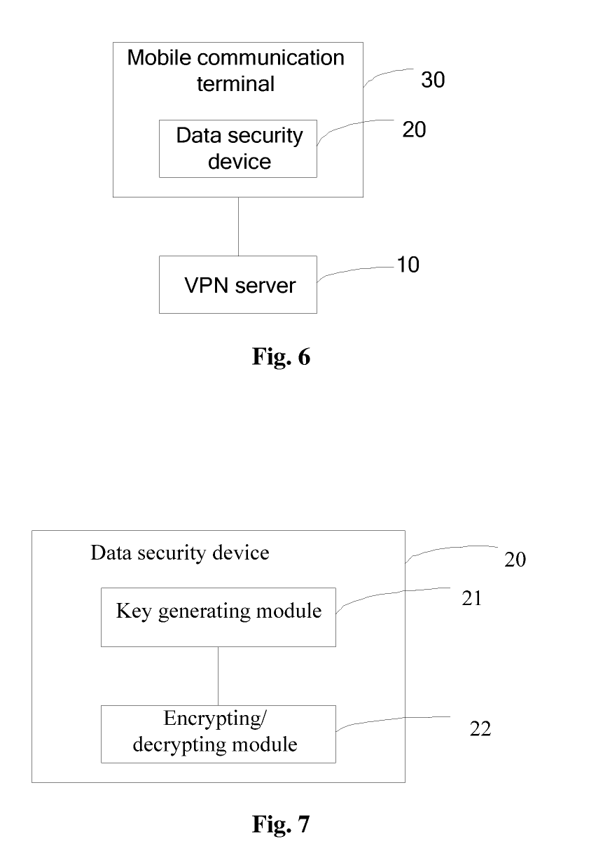

Referring to FIG. 6, an embodiment of a VPN-based system for a mobile communication terminal to access data securely is disclosed, which comprises a VPN server 10 and a data security device 20. The VPN server 10 is configured to inhibit the mobile communication terminal from accessing an intranet when the data security device 20 is not operating in the mobile communication terminal, and the data security device 20 is configured to allow the mobile communication terminal to access the intranet but inhibit the mobile communication terminal from accessing an external network.

In this embodiment, for convenience of description, a mobile communication terminal environment having no data security device 20 operating therein is termed as a private environment, and a mobile communication terminal environment having the data security device 20 operating therein is termed as an office environment. After the user connects to a VPN via a mobile communication terminal 30, the VPN-based data security device 20 is downloaded and then installed in the mobile communication terminal 30 automatically. The VPN-based data security device 20 operates in the background to provide a file system access filtering layer for the mobile communication terminal 30, thus forming an office environment. When an application running in the office environment accesses a network through use of a network API function, the accessing behavior will firstly be intercepted by the data security device 20. The data security device 20 determines whether the accessed destination address is a VPN intranet resource authorized to the user or not. If the destination address is an authorized intranet address, then data will be transmitted to the intranet through a VPN channel; and if the destination address is not an authorized address, then the accessing behavior will be inhibited directly. Applications running in a private environment don't link up with the data security device 20, so even if the destination address to which network data is sent in the private environment is the intranet address, the network data still can not be transmitted to the intranet and the applications can not access the VPN intranet resources. In this way, the office environment can access the intranet but can not access the external network, while the private environment can access the external network but can not access the intranet. As a result, the office environment and the user's private environment are inhibited from communicating with each other, thus achieving the objective of separating the office environment from the user's private environment.

In this embodiment, the data security device 20 is disposed in the mobile communication terminal 30. The data security device 20 cooperates with the VPN server 10 to inhibit the user of the mobile communication terminal from sending protected files to an external network via a network when the data security device 20 is deactivated and to inhibit applications running on the data security device 20 from accessing networks outside the VPN resources to release the protected files to the external network.

Referring to FIG. 7, in an embodiment, the data security device 20 comprises:

a key generating module 21, being configured to generate an encryption key; and

an encrypting/decrypting module 22, being configured to encrypt/decrypt data in the mobile communication terminal 30 according to the encryption key.

When the mobile communication terminal 30 is connected to the VPN, all of the applications running in the mobile communication terminal 30 must pass through the file system access filtering layer of the data security device 20 to access the file system of the mobile communication terminal, and the file system access filtering layer controls the applications' access according to different rights. The key generating module 21 generates an encryption key, and the encrypting/decrypting module 22 is configured to encrypt/decrypt data read from or written into the file system of the mobile communication terminal 30 in the office environment. When the applications running in the office environment write data into the file system of the mobile communication terminal 30, the encrypting/decrypting module 22 utilizes the encryption key to encrypt the file content; and when the applications running in the office environment need to read downloaded files, the encrypting/decrypting module 22 obtains plaintext data by utilizing the encryption key to decrypt the file content and then outputs the plaintext data. The entire process of encrypting/decrypting the files is transparent to the user and is done automatically.

In this embodiment, as the data security device 20 encrypts/decrypts the files transparently for the applications running in the office environment, the applications running in the private environment can not read data (which have already been encrypted in the office environment) through decrypting. Thus, the objective of separating data of the office environment from that of the user's private environment is achieved.

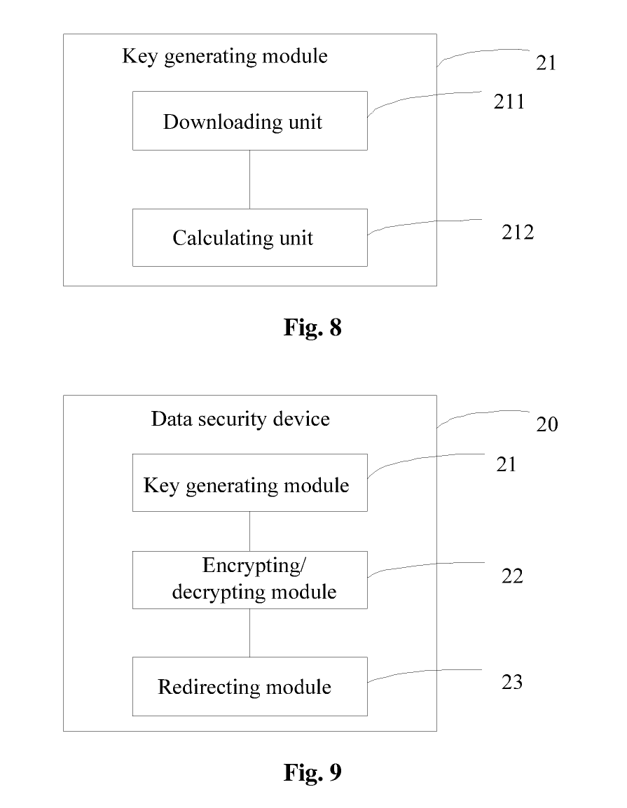

Referring to FIG. 8, in the aforesaid embodiment, the key generating module 21 comprises:

a downloading unit 211, being configured to download a key corresponding to the mobile communication terminal 30 from the VPN server 10 when the mobile communication terminal 30 accesses the VPN resources; and

a calculating unit 212, being configured to calculate an encryption key according to the key and mobile communication terminal parameters. The mobile communication terminal parameters comprise IMEI information and/or IMSI information of the mobile communication terminal 30.

Every time the mobile communication terminal 30 accesses the VPN resources, the downloading unit 211 downloads from the VPN server 10 a unique key associated with a VPN account of the mobile communication terminal 30.

The calculating unit 212 uses the downloaded key cooperate in combination with the mobile communication terminal parameters of the mobile communication terminal 30 to generate the encryption key. The mobile communication terminal parameters may be IMEI information and/or IMSI information or other mobile communication terminal parameters that can be involved in the calculation of the encryption key.

In this embodiment, the data security device 20 generates the encryption key according to the downloaded key every time the mobile communication terminal 30 accesses the VPN resources, so even if the mobile communication terminal 30 is lost, data in the mobile communication terminal 30 will not be disclosed because the key keeps changing constantly.

Referring to FIG. 9, in the aforesaid embodiment, the data security device 20 further comprises:

a redirecting module 23, being configured to redirect data written into the mobile communication terminal 30 to a preset storage space. The preset storage space is a storage space specified in the mobile communication terminal 30 or a storage medium connected with the mobile communication terminal 30.

When the applications running in the office environment writes a file (the file is termed as a virtual file in this embodiment) into the mobile communication terminal 30, the write operation is firstly intercepted by the redirecting module 23. The redirecting module 23 will automatically redirect the write operation of the file to the preset storage space (termed as a real-world file), which may be the storage space specified in the mobile communication terminal 30 or the storage medium connected with the mobile communication terminal 30 such as a SD card. The redirecting module 23 utilizes the encryption key to encrypt the file content. Meanwhile, the redirecting module 23 stores data of correspondence relationships between the real-world file and the virtual file in the preset storage space. When the applications running in the office environment need to read a downloaded file, the redirecting module 23 obtains the real-world file corresponding to the virtual file and redirects the read operation of the virtual file to the corresponding real-world file in the preset storage space. Moreover, the redirecting module 23 obtains plaintext data by utilizing the encryption key to decrypt the content of the real-word file and then outputs the plaintext data to a top layer application. When the virtual file is deleted, the corresponding real-world file and the data of correspondence relationships will be deleted automatically. The entire process of redirecting and encrypting/decrypting the file is transparent to the user and is done automatically.

In this embodiment, as the data security device 20 only redirects the applications running in the office environment transparently, the read or write operation will firstly be intercepted by the data security device 20 when the applications running in the private environment read or write the virtual file. The data security device 20 will not redirect the read or write operation of the file to the real-world file, so the applications only operate on the virtual file but not operate on the real-world file to modify or obtain the content of the real-world file, and this further improves the security of data.

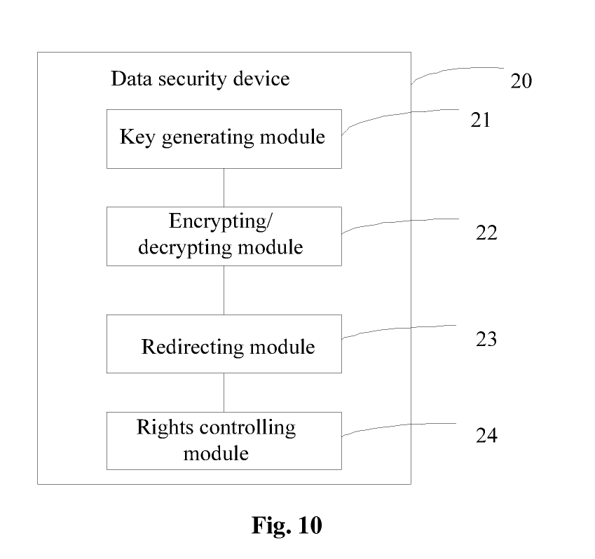

Referring to FIG. 10, in the aforesaid embodiment, the data security device 20 further comprises:

a rights controlling module 24, being configured to control the access of the mobile communication terminal 30 to the VPN resources according to a preset rights policy.

The data security device 20 provides an office environment interface for the user, and application icons currently installed on the mobile communication terminal 30 are shown on the interface. The rights controlling module 24 is configured to determine whether the application icons are displayed or not according to the preset rights policy (which is generally a rights policy issued by the VPN). The rights controlling module 24 only allows applications activated by clicking on the icons (termed as the applications running in the office environment) to access the VPN intranet resources, but inhibits the applications from accessing other network resources outside the VPN intranet resources allocated to the user. On the other hand, applications running in other ways (termed as the applications running in the private environment) are inhibited from accessing the intranet resources by the rights controlling module 24.

In this embodiment, the data security device 20 determines which applications can or can not be used and what VPN resources can or can not be accessed in the office environment according to the preset rights policy, and this further improves the security of the access of the mobile communication terminal 30 to data.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

1. A VPN-based method for a mobile communication terminal to access data securely, comprising:
when a data security device is operating in the mobile communication terminal, the data security device allows the mobile communication terminal to access an intranet but inhibits the mobile communication terminal from accessing an external network; and
when the data security device is not operating in the mobile communication terminal, a Virtual Private Network (VPN) server inhibits the mobile communication terminal from accessing the intranet.

2. The VPN-based method for a mobile communication terminal to access data securely of claim 1, wherein operations of the data security device comprise:
generating an encryption key by the data security device; and
encrypting/decrypting data in the mobile communication terminal according to the encryption key.

3. The VPN-based method for a mobile communication terminal to access data securely of claim 2, wherein generating an encryption key by the data security device comprises:
downloading a key corresponding to the mobile communication terminal from the VPN server when the mobile communication terminal accesses VPN resources; and
calculating an encryption key according to the key and mobile communication terminal parameters, wherein the mobile communication terminal parameters comprise International Mobile Equipment Identity (IMEI) information and/or International Mobile Subscriber Identity (IMSI) information of the mobile communication terminal.

4. The VPN-based method for a mobile communication terminal to access data securely of claim 2, further comprising the following step before encrypting/decrypting data in the mobile communication terminal according to the encryption key:
redirecting data written into the mobile communication terminal to a preset storage space, wherein the preset storage space is a storage space specified in the mobile communication terminal or a storage medium connected with the mobile communication terminal.

5. The VPN-based method for a mobile communication terminal to access data securely of claim 1, wherein operations of the data security device further comprise:
controlling the mobile communication terminal's access to the VPN resources according to a preset rights policy by the data security device.

6. A VPN-based system for a mobile communication terminal to access data securely, comprising a VPN server and a data security device, wherein the VPN server is configured to inhibit the mobile communication terminal from accessing an intranet when the data security device is not operating in the mobile communication terminal, and the data security device is configured to allow the mobile communication terminal to access the intranet but inhibit the mobile communication terminal from accessing an external network.

7. The VPN-based system for a mobile communication terminal to access data securely of claim 6, wherein the data security device comprises:
a key generating module, being configured to generate an encryption key; and
an encrypting/decrypting module, being configured to encrypt/decrypt data in the mobile communication terminal according to the encryption key.

8. The VPN-based system for a mobile communication terminal to access data securely of claim 7, wherein the key generating module comprises:
a downloading unit, being configured to download a key corresponding to the mobile communication terminal from the VPN server when the mobile communication terminal accesses VPN resources; and
a calculating unit, being configured to calculate an encryption key according to the key and mobile communication terminal parameters, wherein the mobile communication terminal parameters comprise IMEI information and/or IMSI information of the mobile communication terminal.

9. The VPN-based system for a mobile communication terminal to access data securely of claim 7, wherein the data security device further comprises:
a redirecting module, being configured to redirect data written into the mobile communication terminal to a preset storage space, wherein the preset storage space is a storage space specified in the mobile communication terminal or a storage medium connected with the mobile communication terminal.

10. The VPN-based system for a mobile communication terminal to access data securely of claim 6, wherein the data security device further comprises:
a rights controlling module, being configured to control the mobile communication terminal's access to the VPN resources according to a preset rights policy.

11. The VPN-based method for a mobile communication terminal to access data securely of claim 3, further comprising the following step before encrypting/decrypting data in the mobile communication terminal according to the encryption key:
redirecting data written into the mobile communication terminal to a preset storage space, wherein the preset storage space is a storage space specified in the mobile communication terminal or a storage medium connected with the mobile communication terminal.

12. The VPN-based method for a mobile communication terminal to access data securely of claim 2, wherein operations of the data security device further comprise:
controlling the mobile communication terminal's access to the VPN resources according to a preset rights policy by the data security device.

13. The VPN-based method for a mobile communication terminal to access data securely of claim 3, wherein operations of the data security device further comprise:
controlling the mobile communication terminal's access to the VPN resources according to a preset rights policy by the data security device.

14. The VPN-based system for a mobile communication terminal to access data securely of claim 8, wherein the data security device further comprises:
a redirecting module, being configured to redirect data written into the mobile communication terminal to a preset storage space, wherein the preset storage space is a storage space specified in the mobile communication terminal or a storage medium connected with the mobile communication terminal.

15. The VPN-based system for a mobile communication terminal to access data securely of claim 7, wherein the data security device further comprises:
a rights controlling module, being configured to control the mobile communication terminal's access to the VPN resources according to a preset rights policy.

16. The VPN-based system for a mobile communication terminal to access data securely of claim 8, wherein the data security device further comprises:
a rights controlling module, being configured to control the mobile communication terminal's access to the VPN resources according to a preset rights policy.
